(19) United States
(12) Patent Application Publication
(10) Pub. No.: US 2017/0352079 A1
(43) Pub. Date: Dec. 7, 2017

(54) ELECTRONIC SERVICE MANAGEMENT SYSTEMS AND METHODS

(71) Applicant: Intertrust Technologies Corporation, Sunnyvale, CA (US)

(72) Inventor: Yutaka Nagao, Cupertino, CA (US)

(73) Assignee: Intertrust Technologies Corporation, Sunnyvale, CA (US)

(21) Appl. No.: 15/613,204

(22) Filed: Jun. 3, 2017

Related U.S. Application Data
(60) Provisional application No. 62/345,340, filed on Jun. 3, 2016.

(51) Int. Cl. G06Q 30/06

(52) U.S. Cl. CPC G06Q 30/0609; G06Q 30/0605

(57) ABSTRACT

This disclosure relates to systems and methods for managing electronic services using a trusted service. Entities may transmit an indication of associated electronic services and associated conditions to the trusted service. Users interested in the electronic services may transmit requests to the trusted service with associate request conditions. The trusted service may analyze the conditions associated with the electronic services and associated requests to determine a degree of agreement and/or fit between the electronic services and the requested services. In further, the trusted service may package one or more electronic services connection with satisfying a request and/or associated conditions by an interested user.

### RELATED APPLICATIONS

This application claims the benefit of priority under 35 U.S.C. §119(e) to U.S. Provisional Application No. 62/345,340, filed Jun. 3, 2016, and entitled “TRANSACTION MANAGEMENT SYSTEMS AND METHODS,” which is hereby incorporated by reference in its entirety.

### COPYRIGHT AUTHORIZATION

Portions of the disclosure of this patent document may contain material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### SUMMARY

The present disclosure relates generally to the management of electronic services. More specifically, but not exclusively, the present disclosure relates to managing electronic services and transactions associated with electronic services using a trusted service.

In an electronic commerce ecosystem, individuals may wish to offer certain electronic services to a wide variety of users under certain conditions. Moreover, users may wish to obtain certain electronic services under specified conditions. It may be difficult, however, for entities offering their electronic services and/or users interested in obtaining electronic services to connect and engage in an electronic transaction meeting the conditions of both parties. Entities and/or users may further be interested in protecting certain private and/or otherwise personal information when engaging in electronic transactions.

Consistent with embodiments disclosed herein, a trusted service may be used in connection with managing electronic services, including transactions involving electronic services, between one or more parties. Service providers may transmit an indication of associated electronic services and associated conditions to the trusted service. In some embodiments, the indication of electronic services may further include information associated with the service providers.

Users interested in the electronic services may transmit information to the trusted service relating to requested services, conditions associated with such requests, and/or information relating to the requesting user. The trusted service may manage a secure transaction between the service providers and the users involving the electronic services. In certain embodiments, this may include analyzing conditions associated with the electronic services and associated requests to determine a degree of agreement and/or fit between the electronic services and the requested services. In further embodiments, the trusted service may package one or more electronic services associated with multiple entities in connection with meeting a request and/or associated conditions by an interested user. Users requesting electronic services and/or entities associated with electronic services may be presented with one or more proposed electronic interactions, and may then engage in such electronic interactions either independently from and/or facilitated by the trusted service.

### BRIEF DESCRIPTION OF THE DRAWINGS

The inventive body of work will be readily understood by referring to the following detailed description in conjunction with the accompanying drawings, in which:

FIG. 1 illustrates an example of an electronic service management architecture consistent with embodiments of the present disclosure.

FIG. 2 illustrates an example of management of an electronic service consistent with embodiments of the present disclosure

FIG. 3 illustrates an example of a method for managing electronic services consistent with embodiments of the present disclosure

FIG. 4 illustrates an exemplary system that may be used to implement embodiments of the systems and methods of the present disclosure.

### DETAILED DESCRIPTION

A detailed description of the systems and methods consistent with embodiments of the present disclosure is provided below. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

The embodiments of the disclosure may be understood by reference to the drawings, wherein like parts may be designated by like numerals or descriptions. The components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure but is merely representative of possible embodiments of the disclosure. In addition, the steps of any method disclosed herein do not necessarily need to be executed in any specific order, or even sequentially, nor need the steps be executed only once, unless otherwise specified.

Embodiments disclosed herein provide for a trusted service that may manage interactions relating to electronic services between one or more parties. Electronic service providers may securely transmit indications of their associated electronic services, conditions associated with the electronic services, and/or secure information relating to the electronic services and/or associated entities to the trusted service. Similarly, users interested in the electronic services may transmit information to the trusted service relating to requested services, conditions associated with such requests, and/or information relating to the requesting users. The trusted service may act as a trusted intermediary, managing a secure transaction involving the electronic services by securely analyzing and/or enforcing conditions associated with the electronic services and the requests. In connection with the secure transaction, the privacy of certain secure and/or private information provided to the trusted service by the users and/or service providers may be preserved.

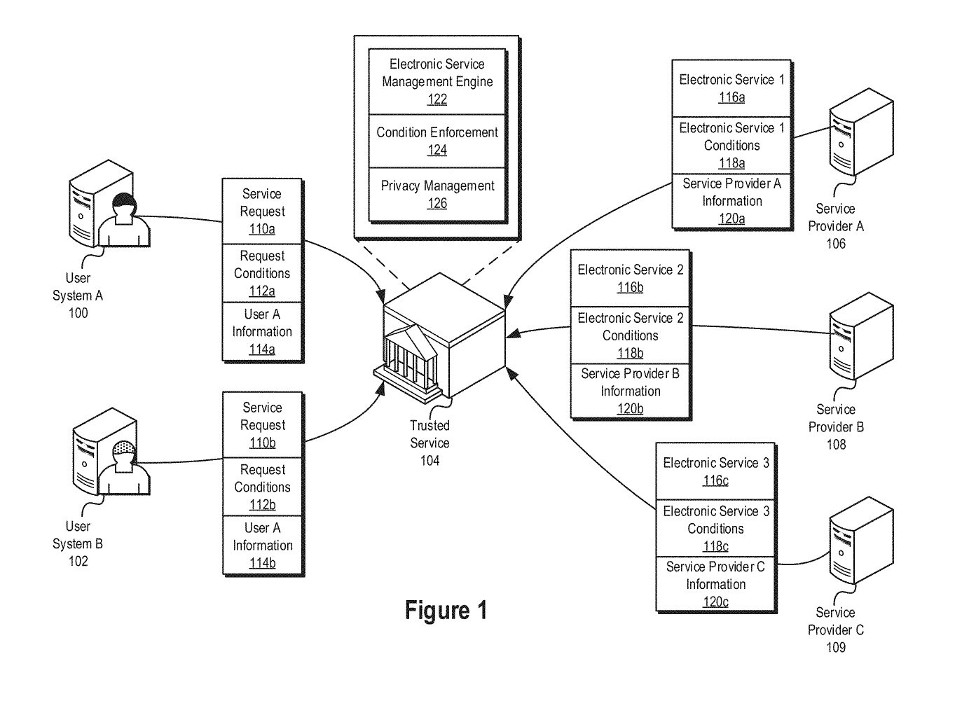

FIG. 1 illustrates an example of an electronic service management architecture consistent with embodiments of the present disclosure. As illustrated, a trusted service 104 be communicatively coupled with one or more user systems 100, 102 and one or more electronic service provider systems 106-109. In some embodiments, the trusted service 104 may act as a trusted intermediary between the user systems 100, 102 and/or the electronic service provider systems 106-109. For example, as detailed below, the trusted service 104 may manage various interactions between the systems 100, 102, 106-109, enforce one or more policies and/or conditions 112a, 112b, 118a-118c specified by the systems 100, 102, 106-109, and/or preserve the privacy of secret information 114a, 114b, 120a-120c communicated to the trusted service 104.

The user systems 100, 102, trusted service 104, service provider systems 106-109, and/or one or more other systems or services (not shown) may comprise any suitable computing system or combination of systems configured to implement embodiments of the systems and methods disclosed herein. In certain embodiments, user systems, user systems 100, 102, trusted service 104, service provider systems 106-109, and/or one or more other systems or services may comprise at least one processor system configured to execute instructions stored on an associated non-transitory computer-readable storage medium. As discussed in more detail below, the user systems 100, 102, trusted service 104, service provider systems 106-109, and/or one or more other systems or services may further comprise a secure processing unit (“SPU”) configured to perform sensitive operations such as trusted credential and/or key management, secure policy and/or condition management, and/or other aspects of the systems and methods disclosed herein. The user systems 100, 102, trusted service 104, service provider systems 106-109, and/or one or more other systems or services may further comprise software and/or hardware configured to enable electronic communication of information between the systems 100-104 and/or services 106-109 via one or more associated network connections.

The user systems 100, 102, trusted service 104, service provider systems 106-109, and/or one or more other systems or services may comprise one or more computing devices executing one or more applications configured to implement embodiments of the systems and methods disclosed herein. In certain embodiments, the user systems 100, 102, trusted service 104, and/or service provider systems 106-109 may comprise at least one of a smartphone, a smartwatch, a laptop computer system, a desktop computer system, a tablet computer, a server computer system, and/or any other computing system and/or device that may be used in connection with the disclosed systems and methods. In certain embodiments, the user systems 100, 102, trusted service 104, and/or service provider systems 106-109 may comprise software and/or hardware configured to, among other things, issue and/or receive service requests 110a, 110b including requested conditions 112a, 112b and/or associated user information 114a, 114b, publish and/or receive information relating to electronic services 116a-116c including associated conditions 118a-118c and/or service provider information 120a-120c, and/or generate one or more electronic service responses configured to provision a user system 100, 102 associated with a granted request 110a, 110b with the requested electronic service. In some embodiments, this may facilitate a transaction between the user systems 100, 102 and/or the electronic service provider systems 106-109.

The user systems 100, 102, trusted service 104, service provider systems 106-109 may communicate using a network comprising any suitable number of networks and/or network connections. The network connections may comprise a variety of network communication devices and/or channels and may use any suitable communication protocols and/or standards facilitating communication between the connected devices and systems. For example, in some embodiments the network may comprise the Internet, a local area network, a virtual private network, and/or any other communication network utilizing one or more electronic communication technologies and/or standards (e.g., Ethernet and/or the like). In some embodiments, the network connections may comprise a wireless carrier system such as a personal communications system (“PCS”), and/or any other suitable communication system incorporating any suitable communication standards and/or protocols. In further embodiments, the network connections may comprise an analog mobile communications network and/or a digital mobile communications network utilizing, for example, code division multiple access (“CDMA”), Global System for Mobile Communications or Groupe Special Mobile (“GSM”), frequency division multiple access (“FDMA”), and/or time divisional multiple access (“TDMA”) standards. In certain embodiments, the network connections may incorporate one or more satellite communication links. In yet further embodiments, the network connections may use IEEE's 802.11 standards, Bluetooth®, ultra-wide band (“UWB”), Zigbee , and or any other suitable communication protocol(s).

Consistent with embodiments disclosed herein, the trusted service 104 may be used in connection with managing interactions between transactions between the user systems 102, 104 and one or more electronic service provider systems 106-109, acting as a trusted intermediary between the systems 100, 102, 106-109. In some embodiments, the electronic service provider systems 106-109 may transmit an indication of associated electronic services 116a-116c to the trusted service 104. In certain embodiments, this may comprise a description of the electronic services 116a-116c and/or information configured to effectuate provisioning of the electronic services 116a-116c.

The electronic service provider systems 106-109 may further transmit to the trusted service 104 an indication of one or more conditions 118a-118c associated with the electronic services 116a-116c. For example, the electronic service provider systems 106-109 may transmit to the trusted service 104 conditions 118a-118c associated with their electronic services 116a-116c that may include, without limitation, a price, a rate, a term, conditions relating to the provisioning of the electronic services 116a-116c such as required user and/or user system attributes (e.g., user and/or system types, user and/or system roles, geographic attributes, demographic attributes, software and/or hardware attributes, service provider and/or peer rating attributes, etc.), actions to be taken in connection with the provisioning of the electronic services 116a-116c, and/or the like.

In further embodiments, the electronic service conditions 118a-118c may articulate requirements relating to the privacy and/or secure handling of service provider information 120a-120c communicated to the trusted service 104. In some embodiments, the various electronic service conditions 118a-118c may be securely associated with the indications of associated electronic services 116a-116a and/or the service provider information 120a-120c (e.g., cryptographically linked and/or the like). It will be appreciated that a variety of types of electronic service provider conditions 118a-118c may be used in connection with managing electronic services 116a-116c, associated service provider information 120a-120c, and/or various interactions in connection with the same, and that any type of conditions and/or polices articulating any restrictions, conditions, requirements, and/or actions to be enforced in connection with the provisioning of electronic services 116a -116c and/or use of the service provider information 120a-120c may be used in connection with the disclosed embodiments.

The user systems 100, 102 may similarly transmit indications of requested electronic services 110a, 110b to the trusted service 104. In some embodiments, the electronic service requests 110a, 110b may comprise a description of one or more electronic services in which the users of the associated user systems 100, 102 are interested. The user systems 100, 102 may further transmit conditions 112a, 112b associated with their electronic service requests 110a, 110b to the trusted service 104. The conditions 112a, 112b may include, without limitation, a requested price, a rate, a term, conditions relating to satisfying the electronic service requests 110a, 110b and/or potential electronic services 116a-116c, such as required service provider and/or service provider system 106-109 attributes (e.g., service provider and/or service provider system types, service provider and/or system roles, geographic attributes, demographic attributes, software and/or hardware attributes, user and/or peer rating attributes, etc.), actions to be taken in connection with the satisfying the electronic service requests 110a, 110b, and/or the like.

The user systems 100, 102 may further transmit to the trusted service 104 certain user information 114a, 114b associated with the users and/or their systems 100, 102 that may be used by the trusted service to evaluate certain conditions 118a-118c specified by service providers 106-109. In further embodiments, the conditions 112a, 112b associated with their electronic service requests 110a, 110b may articulate requirements relating to the privacy and/or secure handling of user information 114a, 114b communicated to the trusted service 104.

In some embodiments, the user conditions 112a, 112b may be securely associated with the electronic service requests 110a, 110b and/or the user information 114a-114b (e.g., cryptographically linked and/or the like). It will be appreciated that a variety of types of conditions 112a, 112b associated with electronic service requests 110a, 110b may be used in connection with managing the requests 110a, 110b, associated user information 114a, 114b, and/or various interactions in connection with the same, and that any type of conditions and/or polices articulating any restrictions, conditions, requirements, and/or actions to be enforced in connection with the electronic service requests 110a, 110b and/or use of the user information 114a-114c may be used in connection with the disclosed embodiments.

In certain embodiments, the trusted service 104 may manage a transaction between the user systems 100, 102 and the electronic service provider systems 106-109 relating to the electronic services 116a-116c. In some embodiments, the trusted service 104 may examine received electronic services 116a-116c and associated conditions 118a-118c to determine if the electronic services 116a-116c and associated conditions 118a-118c satisfy any of the electronic service requests 100a, 110b and associated conditions 112a, 112b. That is, the trusted service 104 may identify possible transactions that satisfy conditions 112a, 112b, 118a-118c of both an electronic service provider system 106-109 and a user system 100, 102.

In some embodiments, the trusted service 104 may identify possible transactions that do not satisfy all conditions 112a, 112b, 118a-118c specified by electronic service provider systems 106-109 and a user system 100, 102, but may satisfy a certain threshold number of conditions 112a, 112b, 118a-118c and/or satisfy the 112a, 112b, 118a-118c conditions within a certain degree. In some embodiments, notification of identified transactions may be provided to the user systems 100, 102 and/or the electronic service provider systems 106-109 by the trusted service 104. The user systems 100, 102 and/or the electronic service provider systems 106-109 may then engage in associated transactions either independently or as facilitated by the trusted service 104.

As discussed above, the trusted service 104 may act as a trusted intermediary, managing the provisioning of the electronic services 116a-116c by securely analyzing and/or enforcing conditions 112a, 112b, 118a-118c associated with the electronic services 116a-116c and the requests 110a, 110b. In some embodiments, the user systems 100, 102 may be unaware of the electronic services 116a-116c and/or associated conditions 118a-118c communicated to the trusted service 104 by the service providers 106-109. Similarly, the service provider systems 106-109 may be unaware of service requests 110a, 110b and/or associated conditions 112a, 112b issued to the trusted service 104 by the user systems 100, 102. In this manner, privacy of the various parties may be preserved, service providers 106-109 may be unable to unfairly discriminate against particular user systems 100, 102 if the user systems 100, 102 meet conditions 118a-118b specified by the service providers 106-109, and user systems 100, 102 may be unable to unfairly discriminate against particular service providers 106-109 if the service providers 106-109 meet conditions 112a, 112b specified by the user systems 100, 102.

In some embodiments, a single electronic service 116a-116c may not satisfy available electronic service requests 110a, 110b issued to the trusted service 104, but multiple electronic service 116a-116c, if combined, may satisfy such requests 110a, 110b. Accordingly, if an electronic service request 110a, 110b may be satisfied by combining multiple electronic services 116a-116c provided by multiple electronic service provider systems 106-109, and associated conditions 112a, 112b, 118a-118c permit such a combination, the trusted service 104 may combine the multiple electronic services 116a-116c and provide an indication of such an aggregated electronic service to the relevant user systems 100, 102 and/or service providers 106-109.

Similarly, in certain embodiments, a single electronic service request 110a, 110b may not satisfy conditions 118a-118c associated with available electronic services 116a-116c, but multiple electronic service requests 110a, 110b, if combined, may satisfy such conditions 118a-118c associated with at least one available electronic service 116a-116c. Accordingly, if conditions 118a-118c associated with available electronic services 116a-116c may be satisfied by combining multiple electronic service requests 110a, 110b provided by multiple user systems 100, 102 and associated conditions 112a, 112b, 118a-118c permit such a combination, the trusted service 104 may combine the multiple electronic service requests 110a, 110b and provide an indication of such an aggregated electronic service request to the relevant user systems 100, 102 and/or service providers 106-109.

Various operations of the trusted service 104 may be performed by one or more engines 122 and/or modules 124, 126 executing on the trusted services 104. For example, an electronic service management engine 122 may receive indications of electronic services 116a-116c from one or more services providers 106-109 and electronic service requests 110a, 110b from one or more user systems 100, 102, match electronic services 116a-116c offered by the service providers 106-109 with one or more electronic service requests 110a, 110b, aggregate electronic services 116a-116c and/or requests 110a, 110b, and/or perform other aspects of the electronic service management methods disclosed herein.

In some embodiments, the electronic service management engine 112 may interact with a condition enforcement module 124 and/or a privacy management module 126 executing on the trusted service 104. The condition enforcement module 124 may analyze conditions associated with service requests 112a, 112b and/or electronic services 118a-118c and enforce the conditions in a trusted manner. Various privacy management operations, including establishing secure communication channels, encrypting various secret information, operations to protect the privacy of shared user information 114a, 114b and/or service provider information 120a-120c, to anonymize information prior to communication from the trusted service, and/or to otherwise protect the privacy of the users of user systems 100, 102 and/or the service providers 106-109 may be performed by the privacy management module 126.

Embodiments of the disclosed systems and methods may be utilized in a variety of interactions with electronic services and/or in connection with a variety of electronic services and/or products. For example, in certain embodiments, the trusted service 104 may operate as a trusted intermediary between parties in an electronic financial transaction such as an electronic cryptographic currency loan transaction.

In some implementations, the trusted service 104 may operate as an intermediary in transactions between prospective lenders and prospective borrowers (e.g., using a virtual currency such as bitcoin and/or the like). For example, a user of a user system 100 may wish to borrow electronic cryptographic currency. The user may generate a service request 110a for a virtual currency loan. As part of the request 110a, the user may indicate a type of virtual currency and how much they wish to borrow (e.g., bitcoin or the like), conditions 112a relating to their requested loan (e.g., acceptable terms, interest rates and/or interest rate ranges, maximum payment, etc.), and/or user information 114a that may be used to assess a relative risk associated with the user (e.g., financial information, credit score information, etc.). The request 110a, associated conditions 112a, and associated user information 114a, may be transmitted by the user system 100 to the trusted service 104.

Based on the received request 110a, associated conditions 112a, and associated user information 114a, the trusted service 104 may, among other things, assess a risk associated with the request 100a and generate an indication of the assessed risk (e.g., via a score or the like). For example, the trusted service 104 may assign a relative risk ranging from a score of 1 to a score of 10. In another example, the trusted service 104 may assign a relative risk ranging from a score of 1 star to 5 stars. The assessed indication of risk may be securely associated with the user request 110a. In certain embodiments, the indication of risk may vary based on policies of the trusted service 104.

In certain embodiments, the trusted service 104 may provide an anonymized indication of the received request 110a that may be viewed by systems associated with prospective lenders (e.g., service provider systems 106-109). For example, the trusted service 104 may provide an indication of the requested type of virtual currency, the requested amount for the loan, conditions 112a relating to the requested loan (e.g., requested term, interest rate and/or interest rate range, maximum payment, etc.), and/or an indication of an assessed risk related to the associated user without providing identifying information of the user (e.g., information 114a).

One or more systems 106-109 associated with prospective lenders may, based on the information provided by the trusted service 104, provide the trusted service 104 with an indication of a type of virtual currency they wish to lend (e.g., electronic service indications 116a-116c), as well as various associated conditions 118a-118c including, for example, a minimum and/or maximum they wish to lend, a required term, interest rate, and/or interest rate range, a minimum associated risk associated with borrowers they are willing to lend to, and/or the like. In certain embodiments, the systems 106-109 associated with the prospective lenders may further provide the trusted service 104 with an indication that they actually possess the funds that they have indicated they wish to lend (e.g., via a certified attribute and/or the like).

In some embodiments, if a type of currency a prospective lender wishes to lend is different than a type of currency a borrower would like to receive in connection with a loan, the trusted service 104 may be configured to offer an exchange of currency. In certain embodiments, a commission may be charged by the trusted service 104 to the prospective lenders (e.g., service providers 106-109) and/or borrowers (e.g., user system 100) for any currency exchanged.

A single prospective service provider 106-109 offering electronic cryptographic currency lending services may not satisfy available loan requests issued by a user system 100. Accordingly, if permitted by associated conditions 112a, 118a-118c, the trusted service 104 may aggregate service offers 116a-116c received from multiple prospective service providers 106-109. In certain embodiments, aggregating available service offers 116a-116c may comprise determining blended loan conditions to generate an aggregated loan offer (e.g., blended interest rates, etc.).

In certain embodiments, the trusted service 104 may allow service providers 106-109 offering electronic cryptographic currency lending services to view and select associated requests 100a that they wish to fund. In other embodiments, selection of prospective lenders may be automated by the trusted service 104 in accordance with one or more policies. For example, in some embodiments, the trusted service 104 may select one or more lending services offered by the service providers 106-109 to provide a prospective borrower with the most favorable and/or least expensive financing terms based on an associated policy.

If further embodiments, interactions between the user transmitting the user request 100a to the trusted service 104 and the various service providers 106-109 may be managed to preserve the anonymity of the various parties. For example, as discussed above, the trusted service 104 may act as a trusted intermediary, managing the provisioning of the electronic services 116a-116c by securely analyzing and/or enforcing conditions 112a, 112b, 118a-118c associated with the electronic services 116a-116c and the requests 110a, 110b in a manner that does not expose confidential and secret information such as the identities of the various parties. In this manner, the privacy of the parties may be preserved, as service providers 106-109 offering lending services may be unable to unfairly discriminate against particular users if the users are able to meet the conditions 118a-118b specified by the service providers 106-109, and users may be unable to unfairly discriminate against particular service providers 106-109 if the service providers 106-109 meet conditions 112a specified by the user.

As discussed above, in some embodiments, identifying information relating to prospective borrowers may not be provided to prospective service providers 106-109. In further embodiments, the trusted service 104 may anonymize information relating to prospective borrowers prior to presenting such information to service providers 106-109 in connection with the disclosed systems and methods. In some embodiments, this may comprise presenting prospective service providers 106-109 with information relating to an indicia of a relative risk associated with a prospective borrower and/or non-identifying demographics information relating to the borrower (e.g., geographic location) without providing identifying information such as the prospective borrower's name or organization.

In certain embodiments, based on associated conditions 112a, 118a-118c, if one and/or both of the prospective borrower and/or service providers 106-109 agree to engage in a transaction, the trusted service 104 may close the transaction between the parties by acting as an intermediary to transfer the electronic cryptographic currency from an account associated with the service provider 106-109 to an account associated with the borrower. In some embodiments, this transfer may further comprise a conversion process between different types of virtual currency.

It will be appreciated that a number of variations can be made to the architecture, relationships, and examples presented in connection with FIG. 1 within the scope of the inventive body of work. For example, certain service 106-109 and/or system 100-104 functionalities described above may be integrated into a single service and/or system and/or any suitable combination of services and/or systems in any suitable configuration. In additional, although certain embodiments are described in connection with electronic services that relate to electronic cryptographic currency exchange, it will be appreciated that embodiments of the discloses systems and methods may be used in a variety of other contexts and/or in connection with a variety of other electronic services. Thus it will be appreciated that the architecture, relationships, and examples presented in connection with FIG. 1 are provided for purposes of illustration and explanation, and not limitation.

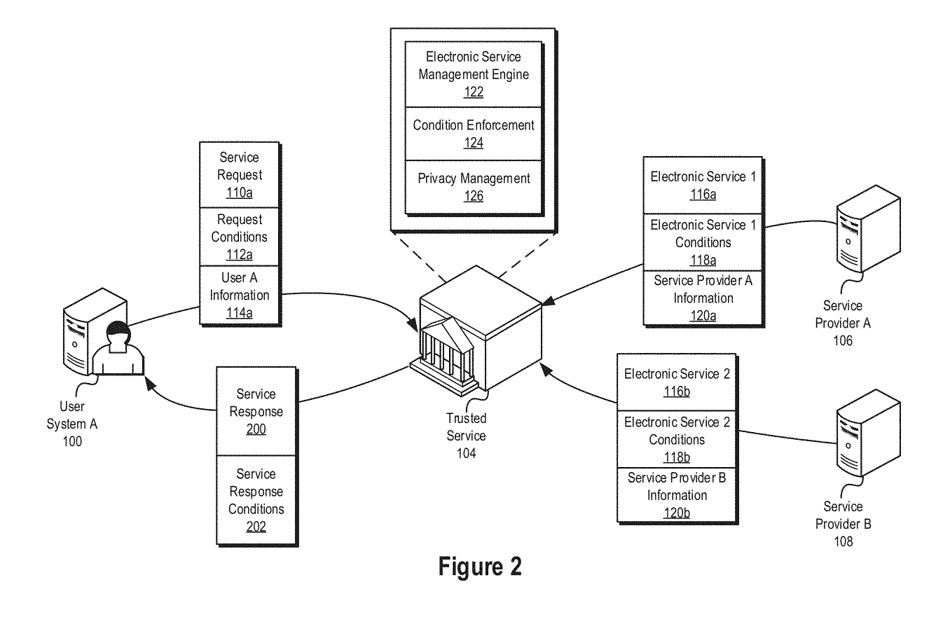

FIG. 2 illustrates an example of a managed transaction consistent with embodiments of the present disclosure. A user system 100 may transmit an indication of a requested service 110a to the trusted service 104, conditions 112a associated with the request 110a, and/or relevant information 114a relating to the associated user. A plurality of electronic service provider systems 106, 108 may transmit indications of associated electronic services 116a, 116b to the trusted service 104. In some embodiments, the service provider systems 106, 108 may further transmit conditions 118a, 118b associated with the electronic services 116a, 116b.

As discussed above, if permitted by associated conditions 112a, 118a, 118b, the trusted service 104 may determine that the user's service request 110a may be fulfilled by combining multiple electronic services 116a, 116b. Accordingly, the electronic service management engine 122 executing on the trusted service 104 may aggregate available electronic service 116a, 116b offers into a single electronic service and return an associated electronic service response 200 and/or associated service response conditions 202 to the user system 102 (e.g., conditions blending the conditions 118a, 118b associated with the constituent electronic services 116a, 116b of the aggregated electronic service). The user system 100 may then accept the service response 200, and the trusted service 104 may act as an intermediary in provisioning of the aggregated electronic service between the user system 100 and the service provider systems 106, 108.

In further embodiments, a service response 200 may be returned by the trusted service 104, comprising either multiple packaged electronic services 116a, 116b or a single electronic service (e.g., electronic service 116a or 116b), that may not necessarily satisfy all conditions 112a and/or other requirements of an associated service request 110a for consideration by a user of a user system 100. For example, in some circumstances, electronic services 116a, 116b, provided to the trusted service 104 by the service providers 106, 108 for offering to user systems 100 may not satisfy all conditions 112a of a service request 110a issued by a user system 100, but may satisfy a certain number of conditions 112a and/or satisfy conditions 112a to a certain degree.

In one example, a user system may issue a service request 110a to the trusted service 104 seeking a loan of a certain amount of electronic cryptographic currency at a specified lending rate, as reflected in conditions 112a associated with the request 110a. The trusted service 104 may determine that available electronic services 116a, 116b offered by the service providers 106, 108 do not meet all conditions 112a of the service request 110a. For example, the electronic services 116a, 116b may comprise lending services at a lower amount and/or at a higher rate than that associated with the service request 110a as reflected in its associated conditions 112a. The trusted service 104 may nevertheless identified that the electronic services 116a, 116b offered by the service providers 106, 108 satisfy a certain number of conditions 112a (e.g., satisfy at least one of an amount of electronic currency or a specified lending rate) or satisfy conditions 112a to a certain degree (e.g., satisfy within a certain amount of the specified amount and/or within a certain percentage of the specified lending rate). Accordingly, the trusted service may return a service response 200 to the user system 100 offering the identified services 116a, 116b for possible acceptance by the user system 100. If the user system 100 accepts the service response 200, the trusted service 104 may act as a trusted intermediary in provisioning of the electronic service(s) 116a, 116b between the user system 100 and the associated provider system(s) 106, 108.

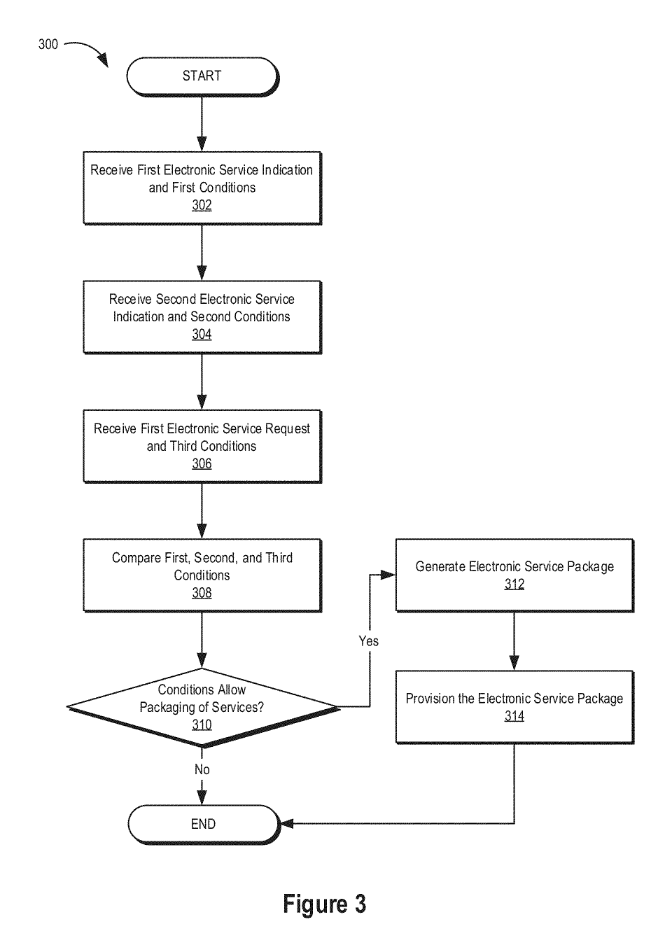

FIG. 3 illustrates an example of a method 300 for managing electronic services consistent with embodiments of the present disclosure. The illustrated method 300 may be implemented in a variety of ways, including using software, firmware, hardware, and/or any combination thereof. In certain embodiments, various aspects of the method 300 may be implemented by one or more systems associated with a user, a trusted service, and/or a service provider. In some embodiments, the illustrated method may provide for condition-based aggregation of electronic services from one or more services providers to satisfy user requests.

At 302, a first electronic service indication may be received by a trusted service from a first service provider system. The first electronic service indication may comprise, one or more first conditions associated with a first electronic service offered by the first service provider system. The one or more first conditions may articulate a variety of conditions relating to the provisioning, access to, and/or use of the first electronic service, including any of the conditions described herein. In some embodiments, the first electronic service indication may comprise information associated with the first service provider system and/or an associated service provider.

At 304, the trusted service may receive a second electronic service indication from a second service provider system. The second electronic service indication may comprise, one or more second conditions associated with a second electronic service offered by the second service provider system. In some embodiments, the second electronic service may be different, at least in part, than the first electronic service. Similarly, in some embodiments, the one or more second conditions may be different, at least in part, than the one or more first conditions.

The one or more second conditions may articulate a variety of conditions relating to the provisioning, access to, and/or use of the second electronic service, including any of the conditions described herein. In some embodiments, the second electronic service indication may further comprise information associated with the second service provider system and/or an associated service provider.

A first electronic service request may be received from a first user system at 306. In some embodiments, the first electronic service request may comprise one or more third conditions associated with the first electronic service request. For example, the one or more third conditions may articulate one more conditions associated with the fulfillment of the first electronic service request.

At 308, the one or more first conditions, the one or more second conditions, and the one or more third conditions may be compared. In some embodiments, based on the comparison at 308, it may be determined that a single electronic service may not satisfy the first electronic service request issued to the trusted service, but that the first electronic service and the second electronic service, if combined, may satisfy the request. At 310, it may be determined whether the one or more first conditions, the one or more second conditions, and the one or more third conditions permit packaging and/or otherwise aggregating the first electronic service and the second electronic service to fulfill the first electronic service request received at 306. If not, the method 300 may proceed to end. If packing of the electronic services is permitted by relevant conditions, the method 300 may proceed to 312.

At 312, an electronic service package may be generated based on the first electronic service and the second electronic service. In some embodiments, generating the electronic service package may be based on the one or more first conditions, the one or more second conditions, and the one or more third conditions. Generating the electronic service package may include securely associating one or more fourth conditions with the electronic service package (e.g., cryptographically associating the conditions with the package). The one or more fourth conditions may be based, at least in part, on the one or more first conditions, the one or more second conditions, and the one or more third conditions.

At 314, the first user system may be provisioned with the electronic service package.

In some embodiments, a single electronic service request may not satisfy conditions associated with available electronic services, but multiple electronic service requests, if combined, may satisfy such conditions associated with at least one available electronic service. For example, in some embodiments, a trusted service may receive, from a service provider system, an electronic service indication that includes one or more first conditions associated with an electronic service. The trusted service may further receive, from a first user system, a first electronic service request that includes one or more second conditions associated with the first electronic service request. Finally, the trusted service may receive, from a second user system, a second electronic service request that includes one or more third conditions associated with the second electronic service request.

The the one or more first conditions, the one or more second conditions, and the one or more third conditions may be compared to determine whether the first electronic service request and the second electronic service request may be packaged and/or otherwise aggregated in a manner that satisfies the one or more first conditions, the one or more second conditions, and the one or more third conditions. If so, an electronic service request package may be generated based on the first electronic service request and the second electronic service request, and the first user system and the second user system may be provisioned with the electronic service.

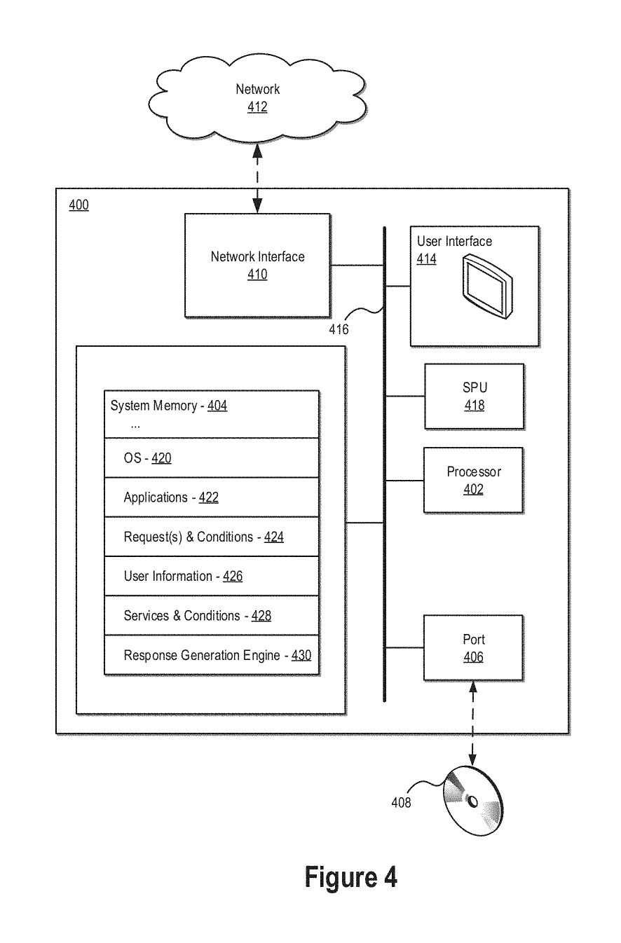

FIG. 4 illustrates an exemplary system 400 that may be used to implement embodiments of the systems and methods of the present disclosure. Certain elements associated with the illustrated exemplary system 400 may be included in a user system, trusted service, a product provider system, and/or any other system configured to implement embodiments of the disclosed systems and methods. As illustrated in FIG. 4, the system 400 may include: a processing unit 402; system memory 404, which may include high speed random access memory (“RAM”), non-volatile memory (“ROM”), and/or one or more bulk non-volatile non-transitory computer-readable storage mediums (e.g., a hard disk, flash memory, etc.) for storing programs and other data for use and execution by the processing unit 402; a port 406 for interfacing with removable memory 408 that may include one or more diskettes, optical storage mediums, and/or other non-transitory computer-readable storage mediums (e.g., flash memory, thumb drives, USB dongles, compact discs, DVDs, etc.); a network interface 410 for communicating with other systems via one or more network connections 412 using one or more communication technologies; a user interface 414 that may include a display and/or one or more input/output devices such as, for example, a touchscreen, a keyboard, a mouse, a track pad, and the like; and one or more busses 416 for communicatively coupling the elements of the system.

In some embodiments, the system 400 may, alternatively or in addition, include an SPU 418 that is protected from tampering by a user of the system 400 or other entities by utilizing secure physical and/or virtual security techniques. An SPU 418 can help enhance the security of sensitive operations such as personal information management, trusted credential and/or key management, privacy, condition, and/or policy management, and other aspects of the systems and methods disclosed herein. In certain embodiments, the SPU 418 may operate in a logically secure processing domain and be configured to protect and operate on secret information, as described herein. In some embodiments, the SPU 418 may include internal memory storing executable instructions or programs configured to enable the SPU 418 to perform secure operations.

The operation of the system 400 may be generally controlled by a processing unit 402 and/or an SPU 418 operating by executing software instructions and programs stored in the system memory 404 (and/or other computer-readable media, such as removable memory). The system memory 404 may store a variety of executable programs or modules for controlling the operation of the system. For example, the system memory 404 may include an operating system (“OS”) 420 that may manage and coordinate, at least in part, system hardware resources and provide for common services for execution of various applications 422 and a trust and privacy management system for implementing trust and privacy management functionality including protection and/or management of personal data through management and/or enforcement of associated policies. The system memory 104 may further include, without limitation, communication software configured to enable in part communication with and by the system; one or more applications 422; electronic service requests and/or associated conditions; user information (e.g., electronic service provider and/or requestor information) 426; available electronic services and/or associated conditions 428; a response generation engine 430; and/or any other information and/or applications configured to implement embodiments of the systems and methods disclosed herein.

The systems and methods disclosed herein are not inherently related to any particular computer, device, service, or other apparatus and may be implemented by a suitable combination of hardware, software, and/or firmware. Software implementations may include one or more computer programs comprising executable code/instructions that, when executed by a processor, may cause the processor to perform a method defined at least in part by the executable instructions. The computer program can be written in any form of programming language, including compiled or interpreted languages, and can be deployed in any form, including as a standalone program or as a module, component, subroutine, or other unit suitable for use in a computing environment. Further, a computer program can be deployed to be executed on one computer or on multiple computers at one site or distributed across multiple sites and interconnected by a communication network. Software embodiments may be implemented as a computer program product that comprises a non-transitory storage medium configured to store computer programs and instructions, that when executed by a processor, are configured to cause the processor to perform a method according to the instructions. In certain embodiments, the non-transitory storage medium may take any form capable of storing processor-readable instructions on a non-transitory storage medium. A non-transitory storage medium may be embodied by a compact disk, digital-video disk, an optical storage medium, flash memory, integrated circuits, or any other non-transitory digital processing apparatus memory device.

Although the foregoing has been described in some detail for purposes of clarity, it will be apparent that certain changes and modifications may be made without departing from the principles thereof. It should be noted that there are many alternative ways of implementing both the systems and methods described herein. Accordingly, the present embodiments are to be considered as illustrative and not restrictive, and the invention is not to be limited to the details given herein, but may be modified within the scope and equivalents of the appended claims.

What is claimed is:

1. A method for aggregating electronic services performed by a trusted service system comprising a processor and a non-transitory computer-readable medium storing instructions that, when executed by the processor, cause the trusted service system to perform the method, the method comprising:
receiving, from a first service provider system, a first electronic service indication, the first electronic service indication comprising one or more first conditions associated with a first electronic service;
receiving, from a second service provider system, a second electronic service indication, the second electronic service indication comprising one or more second conditions associated with a second electronic service;
receiving, from a first user system, a first electronic service request, the first electronic service request comprising one or more third conditions associated with the first electronic service request;
comparing the one or more first conditions, the one or more second conditions, and the one or more third conditions;
determining, based on the comparison, that the first electronic service and the second electronic service may be packaged in a manner that satisfies the one or more first conditions, the one or more second conditions, and the one or more third conditions;
generating an electronic service package based on the first electronic service and the second electronic service; and
provisioning the first user system with the electronic service package.

2. The method of claim 1, wherein the one or more first conditions comprise at least one condition expressing that the first electronic service may be aggregated with one or more other electronic services.

3. The method of claim 1, wherein the one or more second conditions comprise at least one condition expressing that the second electronic service may be aggregated with one or more other electronic services.

4. The method of claim 1, wherein the one or more third conditions comprise at least one condition expressing that the first electronic service request may be satisfied by aggregating a plurality of electronic services.

5. The method of claim 1, wherein generating the electronic service package is further based on the one or more first conditions, the one or more second conditions, and the one or more third conditions.

6. The method of claim 5, wherein generating the electronic service package comprises:
securely associating one or more fourth conditions with the electronic service package, the one or more fourth conditions being based on the one or more first conditions, the one or more second conditions, and the one or more third conditions.

7. The method of claim 6, wherein the one or more fourth conditions are cryptographically associated with the electronic service package.

8. The method of claim 1, wherein the first electronic service is different, at least in part, than the second electronic service.

9. The method of claim 1, wherein the one or more first conditions are different, at least in part, than the one or more second conditions.

10. A method for aggregating electronic service requests performed by a trusted service system comprising a processor and a non-transitory computer-readable medium storing instructions that, when executed by the processor, cause the trusted service system to perform the method, the method comprising
receiving, from a service provider system, an electronic service indication, the electronic service indication comprising one or more first conditions associated with an electronic service;
receiving, from a first user system, a first electronic service request, the first electronic service request comprising one or more second conditions associated with the first electronic service request;
receiving, from a second user system, a second electronic service request, the second electronic service request comprising one or more third conditions associated with the second electronic service request;
comparing the one or more first conditions, the one or more second conditions, and the one or more third conditions;
determining, based on the comparison, that the first electronic service request and the second electronic service request may be packaged in a manner that satisfies the one or more first conditions, the one or more second conditions, and the one or more third conditions;
generating an electronic service request package based on the first electronic service request and the second electronic service request; and
provisioning the first user system and the second user system with the electronic service.
